(19) United States
(12) Patent Application Publication
(10) Pub. No.: US 2021/0365928 A1
(43) Pub. Date: Nov. 25, 2021

(54) TOUCH FREE CREDIT CARD PROCESSING SYSTEM

(71) Applicants: Jeffrey Polacheck, Solana Beach, CA (US); Benjamin Marich, Neenah, WI (US)

(72) Inventors: Jeffrey Polacheck, Solana Beach, CA (US); Benjamin Marich, Neenah, WI (US)

(21) Appl. No.: 17/318,496

(22) Filed: May 12, 2021

Related U.S. Application Data
(60) Provisional application No. 63/027,136, filed on May 19, 2020.

(51) Int. Cl. G06Q 20/34

(52) U.S. Cl. CPC G06Q 20/352

(57) ABSTRACT

The invention is directed to a touch free payment card processing system. The system is formed from a paperboard panel that includes a pocket for a bill and another pocket for placement of a payment card in a detachable portion of the panel. The pocket for the payment card is designed to only partially hold the card and to leave the magnetic strip and/or chip freely available for scanning by a processing device.

### CROSS-REFERENCE TO RELATED APPLICATIONS

The present invention claims priority to and the benefit of U.S. Provisional Patent Application No. 63/027,136 filed May 19, 2020, the contents of which are incorporated herein by reference and made a part hereof.

### FEDERALLY SPONSORED RESEARCH OR DEVELOPMENT

N/A

### FIELD OF THE INVENTION

The present invention is directed to a touch-free payment delivery system. The system provides a platform that enables a customer to receive a bill and insert a payment card into a detachable portion of the system for processing.

### DESCRIPTION OF THE PRIOR ART

Maintaining a safe, sanitized environment has become a primary concern for many industries and places of business during the recent pandemic. In particular, the restaurant industry, and other similar service providers, are taking major steps to stop or slow down the spread of viruses and bacteria that may be harmful to the workers and/or the customers. This is especially difficult given the nature of the services provided in a restaurant or bar, and the extremely large number of people that are served therein.

A number of restaurants are taking certain steps to minimize the spread of viruses. These include having the servers wear masks, spacing customers a safe distance from each other and providing outdoor seating. However, the industry is continually looking for other measures it can take to ensure safety and stop the spread of disease.

The present invention provides a system and method for making payments at a restaurant or other similar location that is safe for the server and the customer.

### SUMMARY OF THE INVENTION

The present invention is directed to a touch free credit card processing system. The processing system is in the form of a restaurant check holder. The system allows for processing of a credit card without direct server contact with the card. The system includes a tear away card holding component that provides access to the magnetic strip of the card or access to a chip on the card. The system can include an antimicrobial coating.

In accordance with one aspect of the invention, a check and payment delivery system is provided in the form of a payment card holder having a detachable portion. The system comprises a first panel having a first pocket for holding only a portion of a payment card. The pocket is positioned on the panel so that a remaining portion of the payment card extends beyond a perimeter of the panel. This provides access to any magnetic strip or chip on the payment card. A tear-away line is provided in the panel for detaching a portion of the panel containing the pocket.

The first panel can comprise a front panel sheet and, a back panel sheet. The front panel sheet can be glued or otherwise adhered to the back panel sheet. The front panel sheet can include a first slit opening for the first pocket.

The first panel can comprise a second pocket for holding a receipt. A second slit opening can be used for the second pocket.

The tear-away line can be formed by perforations in the first panel. Alternatively, the tear-away line can be formed from frangible ribs, a weakened score line or other similar or suitable means.

The first panel can be formed from paperboard. Alternatively, the panel can be formed from plastic, a corrugated material, or other similar or suitable materials. Moreover, the material can be coated with an antimicrobial film or solution.

The system can also include a second panel connected to the first panel by a fold line, or otherwise attached to the first panel. The second panel can comprise a front panel sheet and a back panel sheet glued, or otherwise adhered to the front panel sheet.

The system can further comprise a writing utensil holder. For example, the writing utensil holder can extend from a side of the front panel sheet of the second panel, and have a portion glued to the first panel where the panels are connected.

The second panel can also include a pocket for holding a receipt or a payment card. A slit opening can be provided for the pocket on the second panel.

The first panel (and second panel) can be generally rectangular. However, other shapes can be utilized. The detachable portion of the first panel can be a rectangular shaped corner of the first panel. Again, other shapes can be used.

In accordance with another aspect of the invention, a touch free system for payment by credit card is provided. The system comprises a folder having a first panel and a second panel. A detachable portion is provided in the first panel having a pocket for holding a first portion of a credit card. A second portion of the credit card is therefore accessible for scanning when the detachable portion is detached from the first panel.

The touch free system can include a pocket for holding a receipt, and holder for a writing utensil (such as a pen or a pencil).

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings in which:

FIG. 1 is a perspective view of a touch-free credit card system with a detachable credit card holder in use with other related items in accordance with an aspect of the present invention;

FIG. 2 is a perspective view of the touch-free credit card system of FIG. 1 with a credit card displayed for a server;

FIG. 3 is a perspective view of the touch-free credit card system of FIG. 2 with the detachable credit card holder detached;

FIG. 4 is a perspective view of the detached credit card holder being held by a server with a portion of the credit card extending outward for scanning; and,

FIG. 5 is a plan view of a blank for forming the touch-free system of FIG. 1.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention provides a system for delivering a check and accepting payment via credit or debit card, in a safe, touch-free manner. The system can be made from a recyclable material, such as paperboard, and can include marketing or other informational indicia printed thereon. The system can be utilized in a restaurant, bar, or other similar venues to enable a server to provide customers with a check or bill, and to retrieve a credit or debit card for processing payment without touching the credit card.

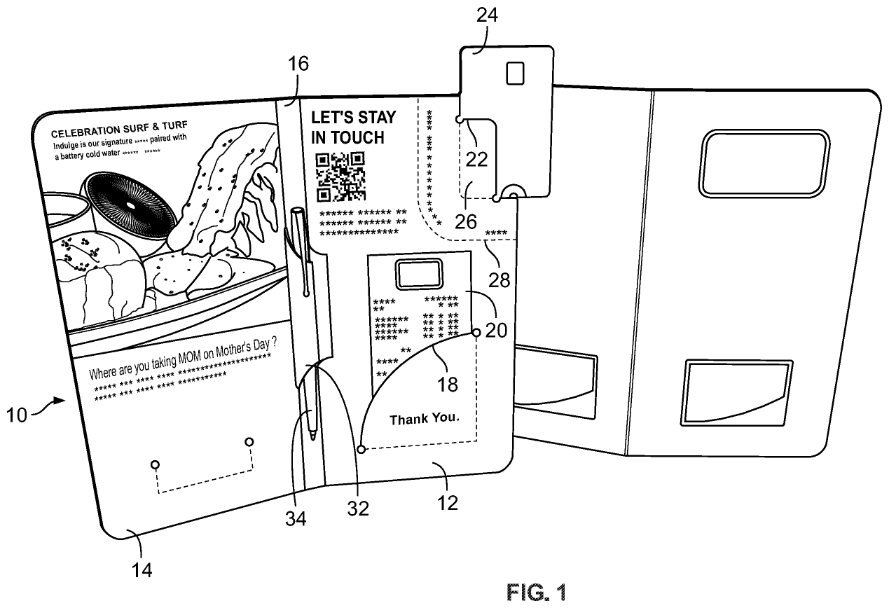

As illustrated in FIG. 1, a check and payment delivery system 10 in accordance with the present invention is shown. The system 10 is in the form of a foldable billfold having a first rectangular panel 12 and a second rectangular panel 14 connected to the first panel 12 by a fold line 16. The first panel 12 includes a pocket 18 for placement of a check or bill 20 by the server. The first panel 12 also includes a pocket 22 for receiving a payment card such as a credit or debit card 24 (the card can also be a gift card or other similar payment method). Alternatively, the check pocket 18 can be on the second panel 14.

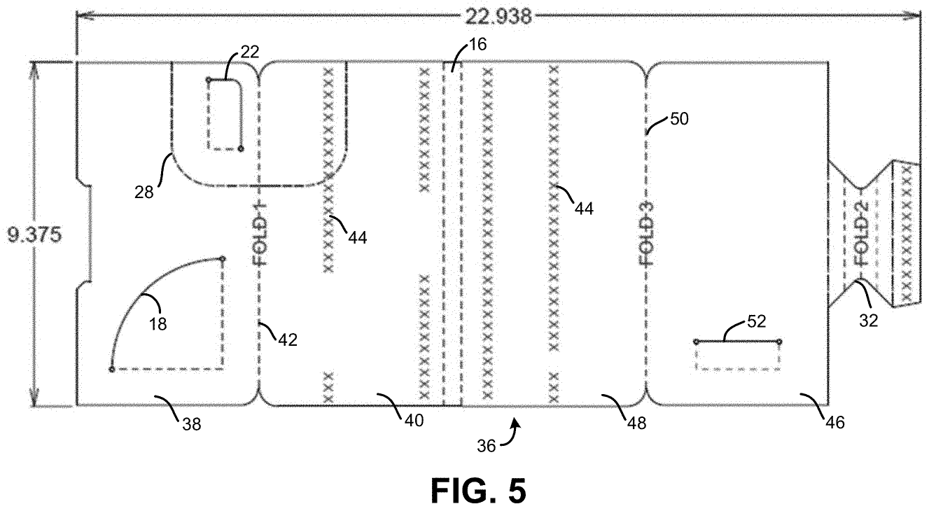

The card holding pocket 22 is positioned proximate one or more edges of the panel 12, and is part of a detachable portion 26 of the first panel 12. In the embodiment illustrated in FIG. 1, the detachable portion 26 is located in the upper right corner of the first panel 12. The detachable portion 26 is connected to the remainder of the first panel 12 by a tear-away line 28 (more clearly shown in FIG. 5). The tear-away line 28 can be formed by perforations in the panel 12. Alternatively, the tear-away line 28 can be formed by frangible ribs or a weakened score line, or by other similar or suitable means.

Breaking the tear-away line 28 separates the detachable portion 26 from the first panel 12 of the system 10 as shown in FIG. 3. This allows a server 30 to take the card 24 held in the detachable portion 26 for payment processing.

The card pocket 22 in the detachable portion 26 is sized to hold only a portion of the card 24. This leaves the magnetic strip and/or the chip on the card 24 exposed for processing with standard card readers. Accordingly, the server 30 does not have to remove the card 24 from the pocket 22 in the detachable portion 26 to process payment, and therefore does not have to physically come into contact with the card 24.

The system is preferably formed from paperboard, or some other similar or suitable material. The material can also be provided with an antimicrobial coating or film.

The system can include other convenient features, such as a holder 32 for a writing utensil 34. As shown in FIG. 1, the writing utensil holder 32 is positioned to hold the writing utensil 34 proximate the fold line 16 of the first and second panels 12, 14.

Preferably, the system 10 is formed from a single blank 36 of material such as the example shown in FIG. 5 (which is the transverse of the embodiment of FIG. 1). In this example, the first panel 12 is formed from a front panel portion or sheet 38 and a back panel portion or sheet 40 connected to the front panel sheet 38 by a fold line 42. A plurality of “x”s 44 in the Figure identify locations for glue or other adhesive means that can be used to connect the front panel sheet 38 to the back panel sheet 40.

The second panel 14 is also formed from a front panel portion or sheet 46 and a back panel portion or sheet 48 connected to the front sheet 46 by a fold line 50. Again, glue 44 or other adhesive means can be used to connect the front sheet 46 to the back sheet 48. The second panel 14 can also be provided with a pocket 52. The pockets 18, 22 and 52 are primarily formed by slits in the respective front sheets 38, 46.

While the system is shown having a first and a second panel 12, 14, the system can be limited to a single panel, or can be part of a more complex design have more than two panels.

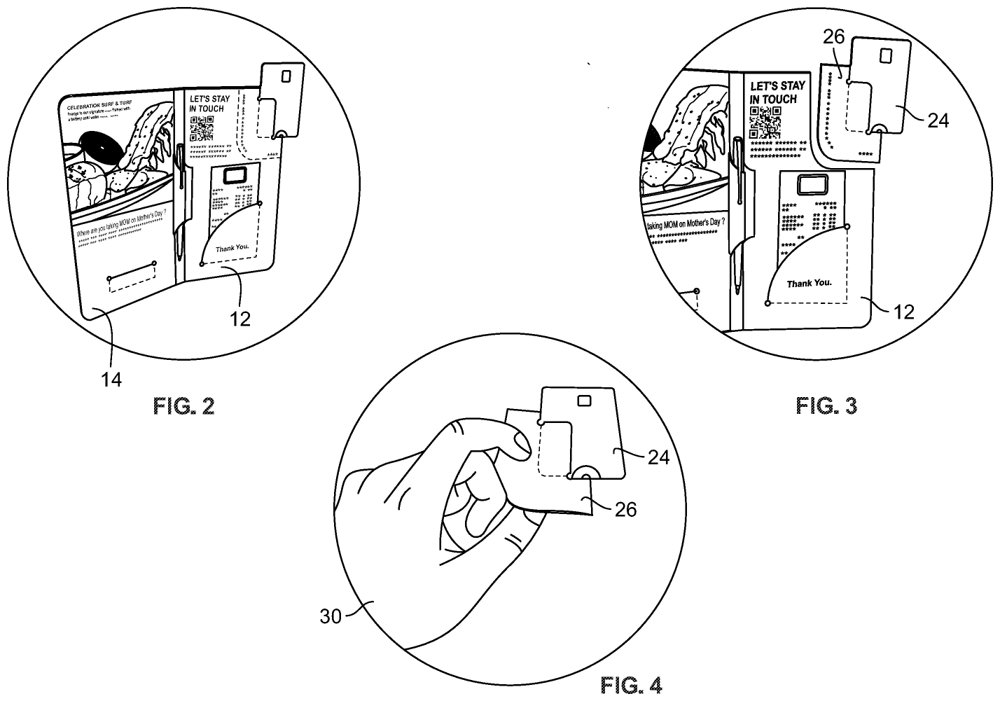

As illustrated in FIGS. 2-4, a customer can place a payment card 24 (e.g., a credit card) in the pocket 22 of the detachable portion 26 of the system 10, and place the system 10 standing upright on the table or counter. The payment card 24 is positioned so that both a magnetic strip and/or a chip embedded in the card 24 is accessible to payment processing devices. The server 30 can then remove the detachable portion 26, via the tear-away line 28 and take the card 24 for processing without touching the card 24.

Many modifications and variations of the present invention are possible in light of the above teachings. It is, therefore, to be understood within the scope of the appended claims the invention may be protected otherwise than as specifically described.

We claim:

1. A check and payment delivery system comprising:
a first panel having a first pocket for holding only a portion of a payment card, the pocket positioned on the panel so that a remaining portion of the payment card extends beyond a perimeter of the first panel; and,
a tear-away line in the panel for detaching a detachable portion of the first panel containing the pocket.

2. The system of claim 1 wherein the first panel comprises:
a front panel sheet; and,
a back panel sheet.

3. The system of claim 2 wherein the front panel sheet is glued to the back panel sheet.

4. The system of claim 3 wherein the front panel sheet includes a first slit opening for the first pocket.

5. The system of claim 4 wherein the first panel comprises a second pocket for holding a receipt.

6. The system of claim 5 wherein the front panel sheet includes a second slit opening for the second pocket.

7. The system of claim 1 wherein the tear-away line is formed by perforations in the first panel.

8. The system of claim 1 wherein the first panel is formed from paperboard.

9. The system of claim 4 further comprising a second panel connected to the first panel by a fold line.

10. The system of claim 9 wherein the second panel comprises:
a front panel sheet; and,
a back panel sheet glued to the front panel sheet.

11. The system of claim 10 further comprising a writing utensil holder extending from a side of the front panel sheet of the second panel, a portion of the writing utensil holder glued to the first panel.

12. The system of claim 9 wherein the second panel includes a second pocket for holding a receipt.

13. The system of claim 12 wherein the second panel includes a second slit opening for the second pocket.

14. The system of claim 1 wherein the first panel is generally rectangular.

15. The system of claim 14 wherein the detachable portion of the first panel is a rectangular shaped corner of the first panel.

16. A touch free system for payment by credit card comprising:
a folder having a first panel and a second panel; and,
a detachable portion in the first panel having a pocket for holding a first portion of a credit card, wherein a second portion of the credit card is accessible for scanning when the detachable portion is detached from the first panel.

17. The system of claim 16 further comprising a receipt holding pocket in the folder.

18. The system of claim 17 further comprising a writing utensil holder in the folder.

19. The system of claim 17 wherein the detachable portion is connected to the first panel by a tear-away line.

20. The system of claim 16 wherein the folder is formed from paperboard.
